(19) United States
(12) Patent Application Publication
(10) Pub. No.: US 2025/0104936 A1
(43) Pub. Date: Mar. 27, 2025

(54) CONTACT CARRIER, CONTACT-CARRIER ARRANGEMENT AND LOW-VOLTAGE PROTECTIVE SWITCHING DEVICE

(71) Applicant: Siemens Aktiengesellschaft, München (DE)

(72) Inventors: Akin Eymelli, Amberg (DE); Michael Jung, Hahnbach (DE); Christine Nitzbon, Hahnbach (DE); Heinz Speil, Amberg (DE)

(21) Appl. No.: 18/728,169

(22) PCT Filed: Nov. 3, 2022
(86) PCT No.: PCT/EP2022/080670

§ 371 Date: Jul. 11, 2024

(30) Foreign Application Priority Data
Jan. 11, 2022 (DE) 10 2022 200 192.3

(51) Int. Cl. H01H 11/06

(52) U.S. Cl. CPC H01H 11/06

(57) ABSTRACT

A contact carrier serves for fastening a contact element of a low-voltage protective switching device by a soldering operation, so that a solder layer is formed between the contact carrier and the contact element. The contact carrier has a contacting area for the solder layer, the contacting area for its part having a rough surface structure and being delimited by a first groove-like depression. As a result of the rough surface structure of the contacting area and the first groove-like depression, when the contact element is being fixed on the contact carrier by soldering, the solder flux can be specifically influenced to the effect that rising up of the solder at the sides of the contact element is avoided, or at least significantly reduced. The quality of the soldered connection, and consequently the reliability of the soldering process, are significantly improved in this way.

The invention relates to a contact carrier for fastening a contact element of a low-voltage protective switching device by means of a soldering operation, so that a solder layer is formed between the contact carrier and the contact element. The invention also relates to a contact-carrier arrangement comprising a contact carrier and a contact element fastened to the contact carrier by soldering, and to a low-voltage protective switching device comprising a contact carrier of this kind and/or a contact-carrier arrangement of this kind.

Electromechanical low-voltage protective switching devices, for example circuit breakers, line circuit breakers of various classes such as MCB (miniature circuit breaker), MCCB (molded case circuit breaker) or ACB (air circuit breaker), but also industrial low-voltage protective switching devices, such as motor circuit breakers, contactors or soft starters, have at least one switching contact with the aid of which the electrical circuit monitored by the respective low-voltage protective switching device can be interrupted when a predefined state, for example a short circuit or a thermal overload, occurs. For this purpose, two contact elements of the switching contact are separated from each other, usually by way of a movable contact element being moved away from a contact element fixedly arranged in the housing of the protective switching device. Here, the term “switching contact” should be understood to mean both single switching contacts with just one contact point and also double-interrupting switching contacts, for example bridge contacts, in which the flow of current to two contacts connected electrically in series is interrupted by means of a contact bridge on which two movable contact elements are arranged.

The actual contact element is usually produced from a silver alloy since these exhibit good electrical conductivity. However, since silver is firstly expensive and secondly relatively soft, the contact carriers, i.e. the components on which the contact elements are fastened and which have to have a certain strength, are not manufactured from silver, but rather from copper or steel. Here, the term “contact carrier” should be understood to mean both a contact carrier arranged fixed in position in a housing of the protective switching device, what is known as a fixed contact carrier, and a contact carrier which can move in the housing, what is known as a moving contact carrier.

The joining process used for fastening the usually cuboidal contact elements on the respective contact carrier is generally a soldering process, for example resistance soldering, in order to obtain good strength of the join, in spite of the relatively low joining temperature. It may be the case here that the solder compound, which, as an intermediate layer between the contact carrier and the contact element, is intended to form a connection with the two joining partners and in this way form a stable join, protrudes laterally below the contact element and rises from the side faces of the contact element. Since the reliability of the joining process and the reliability of the join—and thus the reliability of the low-voltage protective switching device—can be adversely affected as a result, this raised solder portion as it is known should be avoided or kept as small as possible.

The object of the present invention is therefore to provide a contact carrier, a contact-carrier arrangement and a low-voltage protective switching device which prevents or at least reduces the problems mentioned above.

According to the invention, this object is achieved by the contact carrier, the contact-carrier arrangement and the low-voltage protective switching device as claimed in the independent claims. The dependent claims relate to advantageous refinements.

The contact carrier according to the invention serves to fasten a contact element of a low-voltage protective switching device by means of a soldering operation, so that a solder layer is formed between the contact carrier and the contact element, and has a contacting area for the solder layer, the contacting area for its part having a rough surface structure and being delimited by a first channel-like depression.

Depending on the type of switching contact (single or double-interrupting switching contact), two contact elements can also be arranged on one contact carrier. Irrespective of the number of contact elements, the bottom side of the contact element is generally initially coated with the solder when the contact element is joined onto the contact carrier by means of resistance soldering. The contact element, with its bottom side placed onto the contacting area formed on the contact carrier, is heated by means of electric current. Owing to the rough surface structure, which can be created by rough leveling or imprinting for example, the contacting area is provided with a large number of small depressions that serve as solder depots into which the solder liquefied by the heating can run. This results in a relatively small quantity of the liquid solder material protruding laterally below the contact elements and rising from the side faces of the contact element. This is because, with a raised solder portion on one or more side faces of the contact element, there is a risk of the solder running onto the top side of the contact element due to the capillary effect, and this may lead to failure of the low-voltage protective switching device. Furthermore, the contact resistance between the contact element and the contact carrier is increased owing to the rough leveling.

The first channel-like depression, which delimits the contacting area and likewise can be produced by imprinting, serves as a further solder depot, i.e. as receiving volume, into which excess solder material can flow in order to prevent the solder material from rising from one or more of the side faces of the contact element. Furthermore, the binding component of the solder connection, i.e. the proportion of the area connected by the solder connection, is considerably increased. In this way, the flow behavior of the solder material can be influenced in a targeted manner during the soldering operation, so that the raised solder portion can be considerably reduced. The quality of the join—and thus the reliability of joining process—is considerably improved in this way, as a result of which the probability of the low-voltage protective switching device failing can be considerably reduced.

In an advantageous development of the contact carrier, the contacting area is of substantially rectangular shape and has a second channel-like depression which runs in the shape of a sickle from a first corner to an adjacent second corner of the rectangular contacting area.

The second channel-like depression can be produced, for example, by imprinting. With the aid of the second channel-like depression, it is possible to direct the solder flow, i.e. the liquefied solder material, from the middle of the rectangular contacting area in the direction of the corners—and thus into the first channel-like depression which surrounds the contacting area. In this way, the raised solder portion, i.e. rising of the solder material from the side faces of the contact element, can be considerably reduced. Here, the geometry of the second channel-like depression is changed by adapting the width and depth of the sickle to the conditions of the respective contact-carrier arrangement, i.e. to the interaction between a respective contact carrier and a respective contact element.

In a further advantageous development of the contact carrier, the contacting area has a third channel-like depression which runs in the shape of a sickle from a third corner to an adjacent fourth corner of the rectangular contacting area. The effect of the second channel-like depression, limiting the raised solder portion, is further amplified by the third channel-like depression. The second and the third channel-like depression can be arranged symmetrically on the contacting area here.

In a further advantageous development of the contact carrier, the contacting area is completely surrounded by the first channel-like depression. The contacting area is delimited in an encircling manner and thus surrounded without interruption by the first channel-like depression, so that solder material can be largely prevented from escaping to the area of the contact carrier that surrounds the first channel—like depression. The reliability of the joining process is further improved in this way.

In a further advantageous development, the contact carrier is formed from sheet metal, in particular from sheet copper. The use of sheet copper allows good electrical conductivity together with sufficient mechanical stability. The use of the term “copper” includes both pure copper material and also copper alloys here. In addition, the term “sheet metal” is understood to mean a component of which the lateral and the horizontal extent are considerably greater than its vertical extent, i.e. the component has a relatively low thickness or height in comparison to the length and the width extent.

In a further advantageous development, the contact carrier has a rear-side impression in the region of the contacting area. In the region of the contacting area, which is formed on a top side of the contact carrier, the contact carrier has an impression on a bottom side, situated opposite the top side, of the contact carrier. In this way, the flow of current—and thus the heating zone during resistance soldering—can be influenced in a targeted manner. Depending on the variant, the size and contour of the imprint on the bottom side of the contact carrier can be adapted to the respective conditions here.

The contact-carrier arrangement according to the invention for a switching contact of a low-voltage protective switching device has a contact carrier of the kind described above and a contact element fastened to the contact carrier by means of soldering, so that a solder layer is formed between the contact carrier and the contact element.

Reference is made to the statements made above concerning the advantages relating to the contact carrier according to the invention with regard to the general advantages of the contact-carrier arrangement according to the invention. The formulation “by means of soldering” should be understood to mean that the contact element is fastened in a materially bonded manner to the contact carrier using a soldering process, for example the resistance soldering process.

In an advantageous development of the contact-carrier arrangement, the contact element has a convex top side. A bottom side of the contact element faces the contacting area of the contact carrier and is connected to the contact carrier by soldering. The top side, situated opposite the bottom side, of the contact element serves for contacting with a further contact element of the switching contact and for this purpose is of convex design, i.e. is curved upward or outward.

In a further advantageous development of the contact-carrier arrangement, the contact element is formed from a silver alloy. The use of a silver alloy for the contact element has the advantage that silver exhibits good electrical conductivity and the requirements in respect of the strength of the contact element are negligible.

The low-voltage protective switching device according to the invention, for example line circuit breaker, motor circuit breaker or the like, has a contact carrier and/or a contact-carrier arrangement of the kind described above.

Owing to the use of the contact carrier according to the invention and/or the contact-carrier arrangement according to the invention, the quality of the join—and thus the reliability of the joining process—is considerably improved, as a result of which the probability of the low-voltage protective switching device failing can be considerably reduced.

Exemplary embodiments of the contact carrier and the contact-carrier arrangement are explained in more detail below with reference to the appended figures. In the figures:

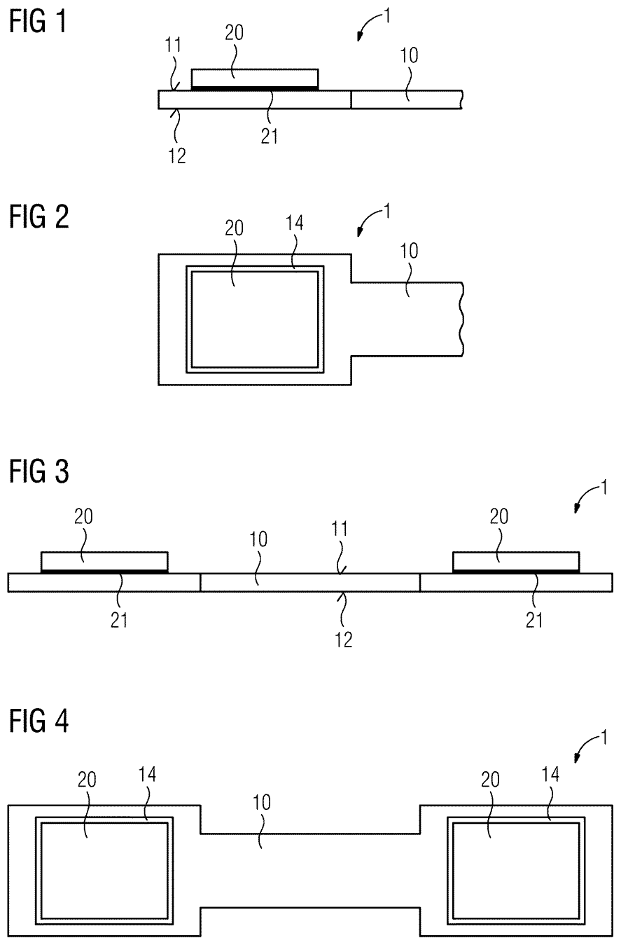

FIGS. 1 and 2 are schematic illustrations of a first exemplary embodiment of a contact-carrier arrangement;

FIGS. 3 and 4 are schematic illustrations of a second exemplary embodiment of the contact-carrier arrangement;

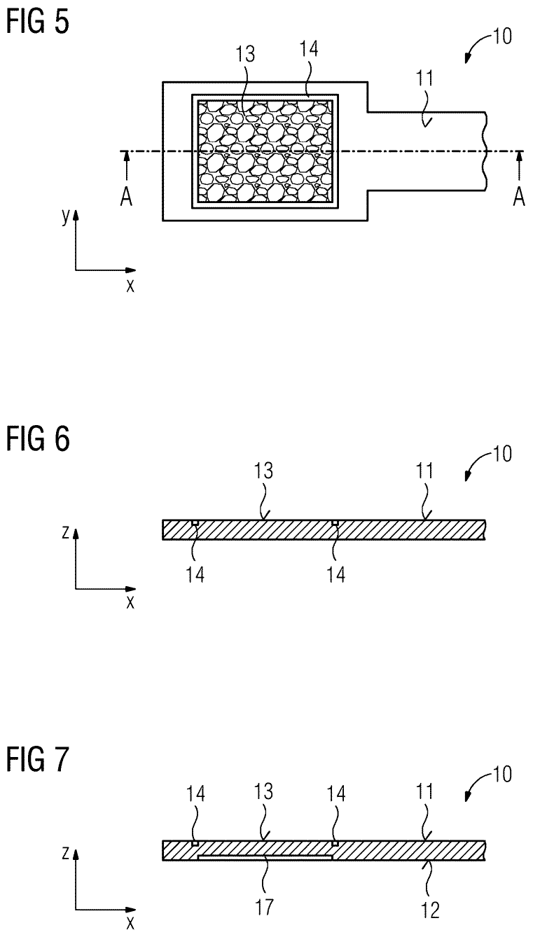

FIGS. 5 and 6 are schematic illustrations of a first exemplary embodiment of the contact carrier according to the invention;

FIG. 7 is a schematic illustration of a second exemplary embodiment of the contact carrier according to the invention;

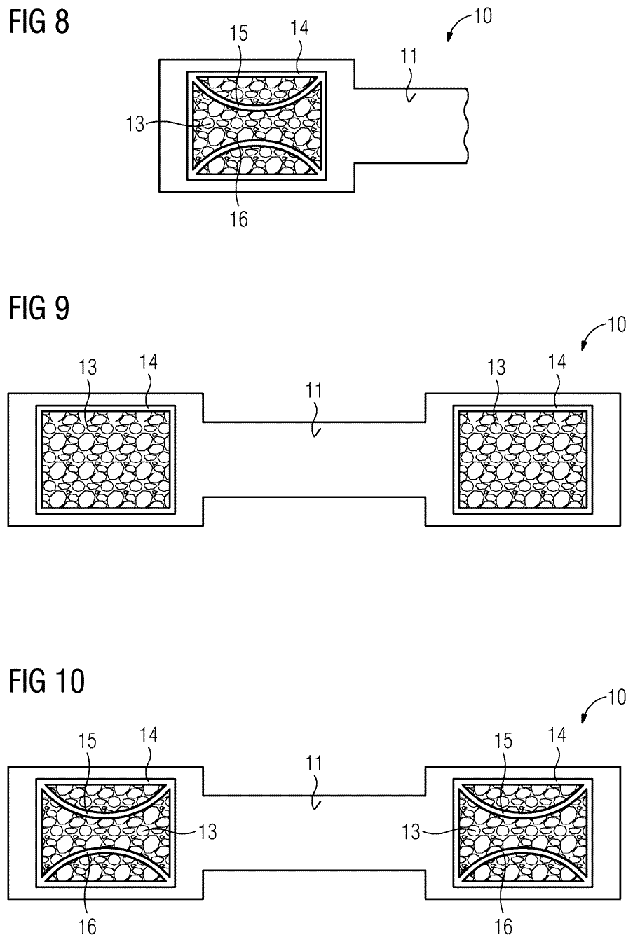

FIG. 8 is a schematic illustration of a third exemplary embodiment of the contact carrier according to the invention; and

FIGS. 9 and 10 are schematic illustrations of a further exemplary embodiment of the contact carrier according to the invention.

In the various figures of the drawing, like parts are always provided with the same reference signs. The description applies to all figures of the drawing in which the relevant part is likewise shown.

FIGS. 1 and 2 schematically show a first exemplary embodiment of a contact-carrier arrangement 1 in horizontal and vertical projection. The contact-carrier arrangement 1 has a contact carrier 10 on which a substantially cuboidal contact element 20 is fastened. The contact element 20 is placed on a contacting area 13 (see FIG. 5 et seq.), provided for this purpose, of the contact carrier 10 and is connected in a materially bonded manner by soldering, so that an areal solder layer 21 is formed between the contacting area 13 of the contact carrier 10 and the contact element 20.

The contact carrier 10 comprises electrically conductive material—for example steel, copper or a combination of both materials, for example copper-plated sheet steel or copper electrochemically applied to sheet steel—and can be produced by stamping for example. The contact element 20 is preferably formed from a silver alloy. Since both the contact carrier 10 and the contact element 20 are electrically conductive, the soldering process used for connecting the two joining partners—the contact element 20 and the contact carrier 10—is preferably resistance soldering. In order to capture excess solder material, the contact carrier 10 also has a first channel-like depression 14 which delimits the contacting area 13 to the outside.

FIGS. 3 and 4 schematically show a second exemplary embodiment of the contact-carrier arrangement 1 in horizontal and vertical projection. The contact-carrier arrangement is what is known as a bridge contact with two switching points connected electrically in series, in the case of which two contact elements 20 are accordingly fastened on the movably mounted contact carrier 10 by means of soldering.

The contact element 20, illustrated in substantially cuboidal form, has a bottom side by way of which it is connected to a top side 11 of the contact carrier 10. A top side, situated opposite the bottom side, of the contact element 20 is embodied as a planar surface oriented parallel to the top side 21 in the illustrations of FIGS. 1 to 4. However, this is not absolutely necessary; it is likewise possible for the top side of the contact element 20 to be spherical, i.e. curved upward, that is to say convex.

FIGS. 5 to 10 schematically illustrate various embodiments of the contact carrier 10 according to the invention in various views. FIGS. 5 and 6 show schematic illustrations of a first exemplary embodiment of the contact carrier 10, where FIG. 5 shows a plan view of the contact carrier 10, whereas FIG. 6 schematically shows a sectional illustration along line of section A-A indicated in FIG. 5.

The contact carrier 10 has a sheet-like form, i.e. its length and width extents in a first direction x and, respectively, a second direction y are considerably greater than its thickness extent in a third direction z. The contact carrier 10 consists of an electrically conductive material and can be produced by stamping for example. The substantially rectangular contacting area 13 for contacting the contact element 20 is formed on the top side 11 of the contact carrier 10. The contacting area 13 has a rough surface structure, which can be produced by imprinting or rough leveling for example, and is delimited by the first channel-like depression 14, which completely surrounds the contacting area 13.

FIG. 7 schematically shows a second exemplary embodiment of the contact carrier 10 according to the invention. FIG. 7 likewise shows a sectional illustration along the line of section A-A indicated in FIG. 5—but the contact carrier 10 illustrated here has an impression 17 on its bottom side 12, situated opposite the top side 11, the impression being formed on the rear side in the region of the contacting area 13. The electric current flowing across the contact carrier—and thus across the contact arrangement-during resistance soldering can be influenced in a targeted manner with the aid of the impression 17, the size and shape of which can be matched to the variant of a low-voltage protective switching device to be formed. The solder projection from the sides of the contact element 20 can be reduced in this way.

FIG. 8 schematically shows a third exemplary embodiment of the contact carrier 10 according to the invention. The illustration of the contact carrier 10 corresponds substantially to the illustration described above in relation to FIG. 5, where the contact carrier 10 now additionally has a second channel-like depression 15 and a third channel-like depression 16 in the region of the rectangular contacting area 13. The two channel-like depressions 15 and 16 are arranged symmetrically in relation to each other and each run in the form of a sickle from one corner to an adjacent corner of the rectangular contacting area 13, here each spanning one of the longitudinal sides of the rectangular contacting area 13.

The second and the third channel-like depression can likewise be produced by imprinting or rough leveling and serve to direct the solder flow away from the sides, toward the corners of the contacting area 13, in order to prevent or at least reduce a solder projection from the sides of the contact element 20. The width and the curvature of the two sickle-shaped channel-like depressions 15 and 16 can be adapted to the respective type of switching device in respect of their size and contour here. The embodiment illustrated in FIG. 8 can be realized with or without a rear-side impression according to the illustrations of FIGS. 6 and 7 here.

In the illustration of FIG. 8, the contacting area 13 has a first and a second channel-like depression; however, it is likewise possible to provide the contacting area 13 with just one of the two sickle-shaped, channel-like depressions 15 and 16.

FIGS. 9 and 10 schematically show further exemplary embodiments of the contact carrier 10 according to the invention in line with the embodiment already known from FIGS. 3 and 4 as a bridge contact in horizontal projection, i.e. looking onto the top side 11 of the contact carrier 10. FIG. 9 shows the contact carrier 10 in the form of a bridge contact with two contacting areas 13, each of which is surrounded by a first channel-like depression 14. The bottom side 12 (see FIGS. 6 and 7) can be designed with or without an impression 17 here. FIG. 10 shows the contact carrier 10 in the form of a bridge contact, where the two contacting areas 13 each also have, in addition to the first channel-like depression 14, the two sickle-shaped channel-like depressions 15 and 16. The bottom side 12 can also be designed with or without an impression 17 here.

Owing to the structural measures described above, i.e. the contacting area 13, a rough surface structure, the first channel-like depression 14 and the two sickle-shaped, channel-like depressions 15 and 16, the solder projection can be considerably reduced. The geometric design of these structural measures can be adapted to the respective conditions of the respective type of switching device depending on contact size, contact material, dimensions of the contact carrier etc.

### LIST OF REFERENCE SIGNS

1 Contact-carrier arrangement
10 Contact carrier
11 Top side
12 Bottom side
13 Contacting area
14 First channel-like depression
15 Second channel-like depression
16 Third channel-like depression
17 Impression
20 Contact element
21 Solder layer
X First direction
Y Second direction
Z Third direction

1-9. (canceled)

10. A contact carrier for fastening a contact element of a low-voltage protective switching device by means of a soldering operation, so that a solder layer is formed between the contact carrier and the contact element, the contact carrier comprising:
a contacting area for the solder layer, said contacting area having a rough surface structure and is delimited by a first channel-shaped depression, said contacting area being of substantially rectangular shape and having a second channel-shaped depression formed therein and running in a shape of a sickle from a first corner to an adjacent second corner of said contacting area being a rectangular contacting area.

11. The contact carrier according to claim 10, wherein said contacting area has a third channel-shaped depression formed therein which runs in a shape of a sickle from a third corner to an adjacent fourth corner of said rectangular contacting area.

12. The contact carrier according to claim 10, wherein said contacting area is completely surrounded by said first channel-shaped depression.

13. The contact carrier according to claim 10, wherein the contact carrier is formed from sheet metal.

14. The contact carrier according to claim 10, wherein the contact carrier has a rear-side impression in a region of said contacting area.

15. The contact carrier according to claim 13, wherein said sheet metal is sheet copper.

16. A contact-carrier configuration for a switching contact of a low-voltage protective switching device, the contact-carrier configuration comprising:
a contact carrier having a contacting area for a solder layer, said contacting area having a rough surface structure and is delimited by a first channel-shaped depression formed in said contact carrier, said contacting area being of substantially rectangular shape and having a second channel-shaped depression formed therein and running in a shape of a sickle from a first corner to an adjacent second corner of said contacting area; and
a contact element fastened to said contact carrier by means of soldering, so that said solder layer is formed between said contact carrier and said contact element.

17. The contact-carrier configuration according to claim 16, wherein said contact element has a convex top side.

18. The contact-carrier arrangement according to claim 16, wherein said contact element is formed from a silver alloy.

19. A low-voltage protective switching device, comprising:
said contact-carrier configuration according to claim 16.

20. The low-voltage protective switching device according to claim 19, wherein the low-voltage protective switching device is a line low-voltage protective switching device.

21. A low-voltage protective switching device, comprising:
said contact carrier according to claim 10.
